(19) United States
(12) Patent Application Publication
(10) Pub. No.: US 2004/0002391 A1
(43) Pub. Date: Jan. 1, 2004

(54) Constant velocity joint

(75) Inventor: Steven Mark Thomas, Saginaw, MI (US)

Correspondence Address: Robert L. Stearns, Reising, Ethington, Barnes, Kisselle,, Learman & McCulloch, P.C., 5291 Colony Drive North, Saginaw, MI, 48603, US

(73) Assignee: DELPHI TECHNOLOGIES INC.

(21) Appl. No.: 10/185,340

(22) Filed: Jun. 27, 2002

(51) Int. Cl. F16D 3/50; F16D 3/36

(52) U.S. Cl. 464/139

(57) ABSTRACT

A constant velocity joint includes a first joint member having a plurality of guide rails that are parallel to one another and to a central axis of the first joint member. A second joint member includes a spider encaged by the guide rails and carrying slide couplings which are captured by but slideable axially on the guide rails and spider as well as being pivotal relative to the spider to facilitate angulation of the joint as well as axial translation during the transmission of torque between two rotatable shafts coupled to the respective first and second joint members.

### BACKGROUND OF THE INVENTION

1. Technical Field

This invention relates generally to constant velocity joints of the type used to transmit torque between two rotating shafts to maintain constant velocity through varying joint angles, and more particularly to those providing both joint angulation and relative axial translation or plunging of the joint members.

2. Related Art

Plunging-type constant velocity joints are well known and typically include an outer joint member formed with three internal ball tracks or channels facing a longitudinal axis of the outer joint member. A spider is disposed within the outer joint member and is provided with radially extending trunnion arms which are received in each of the ball channels. A roller ball or complex ball assembly is carried on each of the trunnion arms and is rollable along each of the respective ball channels to facilitate relative axial translational or plunging movement of the inner and outer joint members, and thus the shafts to which they are connected. The roller balls are further typically supported in some manner for axial displacement along their respective trunnion arms and are able to angulate relative to the trunnion arms in order to maintain tracking of the balls in the ball channels during transmission of torque through an angle between the joint members.

While such joint members find many useful applications in front wheel drive systems of vehicles, and the like, not all applications demand such a robust, costly joint construction. It is an object of the present invention to provide a simple, low cost alternative to conventional plunging-type constant velocity joints.

### SUMMARY OF THE INVENTION AND ADVANTAGES

A constant velocity joint assembly constructed according to a presently preferred embodiment of the invention for use in transmitting torque between two rotatable shafts comprises a first joint member secured to one of the shafts, and a second joint member secured to the other shaft. A torque-transmitting connection is provided between the joint members and includes a plurality of guide rails carried by the first joint member that are disposed in parallel relationship to one another and to an axis of the first joint member and having outer guide surfaces of the guide rails. The torque-transmitting connection further includes a plurality of slide couplings carried by the second joint member and disposed about the outer guide surfaces of the guide rails to support the second joint member against rotation relative to the first joint member such that rotation of one of the joint members imparts corresponding rotation to the other of the joint members through the slide couplings. The slide couplings are slideable with the first joint member axially along the outer guide surfaces of the guide rails to provide relative axial translation or plunging of the joint members. The slide couplings are further slideable on the second joint member transversely of the axis of the second joint member and pivotal relative to the second joint member to accommodate relative angulation of the joint members.

A plunging constant velocity joint having the guide rails and slide connection features of the present invention has the advantage of providing a simply constructed, low cost alternative to conventional tripot-type constant velocity joints. With the guide rails, there is no need to stamp or machine specially configured ball channels in the outer joint member, rather the guide surfaces along which the slide coupling operates are provided by the outer surfaces of the guide rails. The size and weight of the present joint may also be smaller and lighter than conventional tripot-type joints.

### THE DRAWINGS

These and other features and advantages of the present invention will become more readily appreciated when considered in connection with the following detailed description and appended drawings, wherein:

FIG. 1 is an exploded perspective view of a joint constructed according to a presently preferred embodiment of the invention;

FIG. 2 is an isometric view of the assembled joint of FIG. 1;

FIG. 3 is an enlarged fragmentary perspective view, shown partly in section, of a portion of the joint;

FIG. 4 is a cross-sectional view taken generally along lines 4-4 of FIG. 2 with the joint at zero angle;

FIG. 5 is a view like FIG. 4 but showing the joint at an angle; and

FIG. 6 is a side elevational view of an alternative embodiment of the invention.

### DETAILED DESCRIPTION

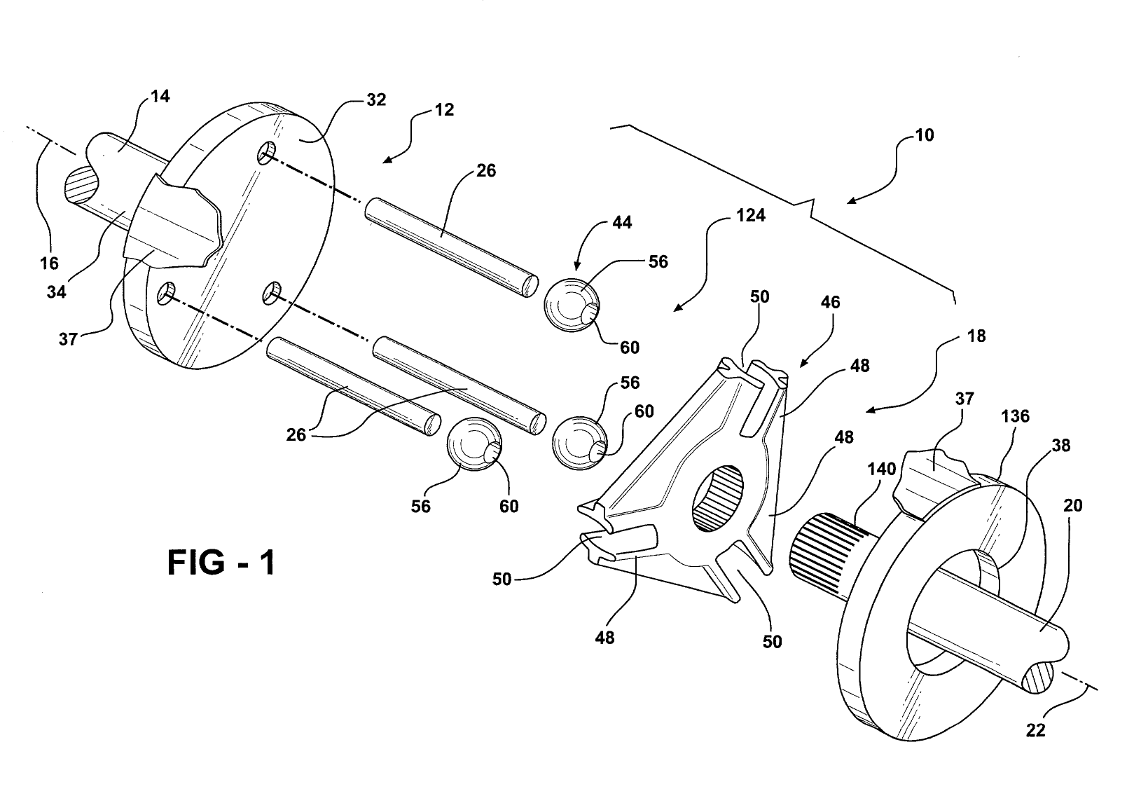

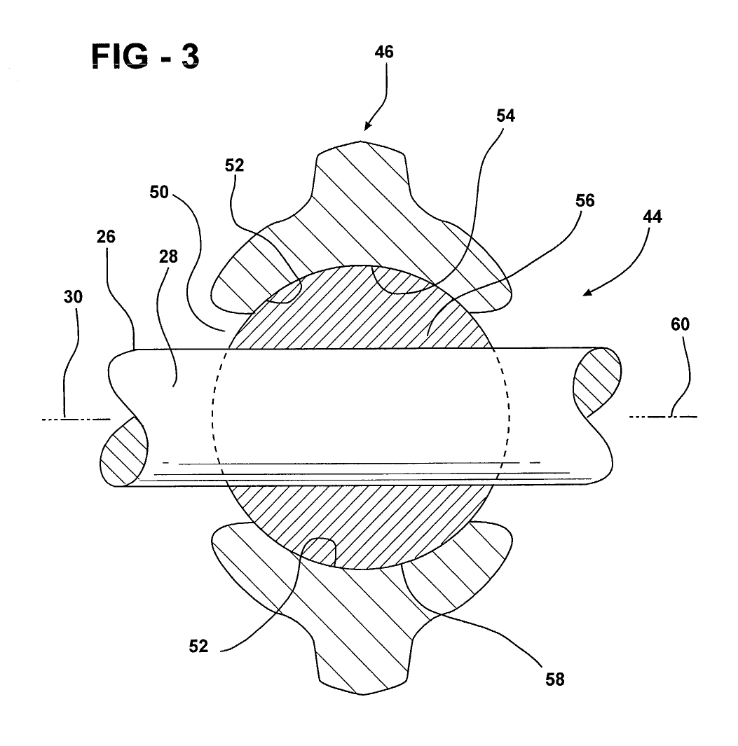

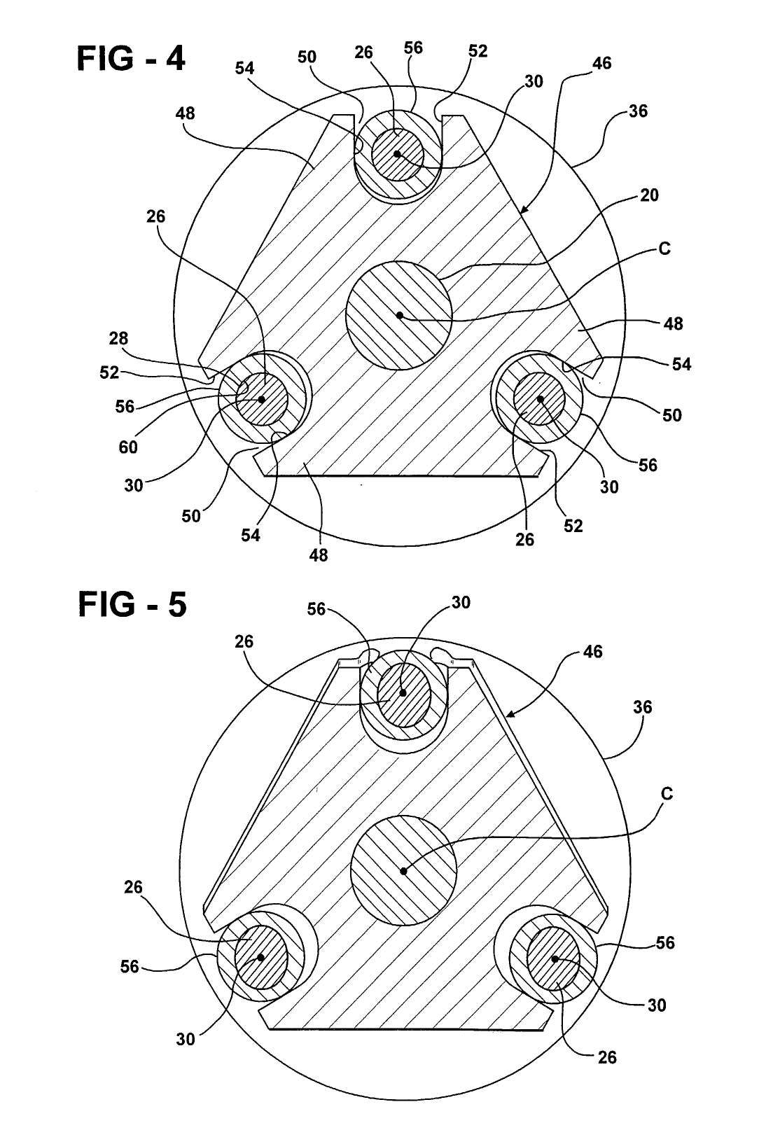

A constant velocity joint assembly or joint 10 constructed according to a first presently preferred embodiment of the invention is shown in FIGS. 1-5 and includes a first joint member 12 that is fixed to a first shaft 14 and rotatable therewith about a first longitudinal axis 16 thereof, and a second joint member 18 fixed to a second shaft 20 and rotatable therewith about a second axis 22 thereof.

The first and second joint members 12, 18 are joined by a torque-transmitting connection 24 that transfers rotation from one joint member to the other while enabling the joint members 12, 18 to angulate from a zero angle in which the first and second axis 16, 22 are coaxially aligned and over a range of positive joint angles of up to about 30° in which the axes are transverse to one another but intersect at a joint center C of the axes, and while also enabling the joint member 12, 18 to translate or plunge in the axial direction, such that one or both joint members 12, 18 are able to slide in the direction of the their axes relative to the other joint member. The torque-transmitting connection 24 also supports the joint members 12, 18 against relative rotation, such that the rotation of one of the joint members imparts corresponding rotation to the other joint member through a zero or positive joint angle and during relative axial plunging of the joint members 12, 18. The torque-transmitting connection 24 has the further characteristic of maintaining a constant velocity of the input and output shaft through the joint members, such that the velocity of the input shaft in the corresponding velocity of the output shaft is maintained constant through the range of joint angles and plunging movements of the joint members 12, 18 through operation of the torque-transmitting connections. Kinematically, the joint assembly 10 operates in the manner of a conventional constant velocity joint of the well-known tripot variety in respect to maintaining a constant velocity between the input and output shafts, but the present joint assembly 10 achieves this characteristic by means of a markedly different joint construction, as is apparent from the drawings and the description below.

The torque-transmitting connection 24 of the joint assembly 10 includes a plurality of guide rails 26 which are fixed to the first joint member 12 in circumferentially spaced, parallel relationship to one another and to the first axis 16. Each of the guide rails 26 has a central guide axes 30 about which the guide surfaces 28 are disposed and extend axially along in the direction of the first axis 16. The outer guide surfaces 28 face radially outwardly of the guide axis 30 such that the material used to make the guide rails 26 is present radially inwardly of the guide surfaces 28. In transverse section, the outer guide surfaces 28 have an outwardly contoured or bowed configuration that may comprise any of a number of geometric shapes including, but not limited to, circular, oval, rectangular, triangular, and any other shape which presents an outer guide surface and enables a member slide along its length. As illustrated in the drawings, the presently preferred construction of the guide rails 26 is that of a plurality of cylindrical rods or pins which are simple and inexpensive to implement in the invention although, as indicated, other rail configurations which function in the same or equivalent manner are contemplated by the invention and incorporated herein by reference. The guide rails or rods 26 are fabricated preferably of a ridged material such as metals, plastics, composites, etc., with the preferred materials being either steel or aluminum. The outer guide surfaces 28 are preferably, although not necessarily, circumferentially continuous along their length.

The first joint member preferably includes and end wall or base 32 fixed to the first shaft 14 adjacent a joint end 34 of the shaft 14 and extending radially outwardly therefrom and supporting the guide rails 26 at one end thereof in their fixed spatial relationship such that the guide axes 30 of the rails 26 are spaced equidistantly from one another and from the first axis 16 of the first joint member 12. As illustrated in the drawings, there are preferably three such guide rails 26, although the invention contemplates a greater or fewer number of rails exceeding one in the context of a plurality of rails 26, with three rails being preferred. The first joint member 12 preferably further includes an opposite end wall 36 spaced axially from the first end wall 32 and joining the guide rails 26 at their opposite axial ends, such that their rails are tied together and supported by the end walls 32, 26 at their ends. The end walls 32, 36 are preferably further joined by an outer housing 37 (shown in fragment) which is preferably cylindrical and which defines a protective enclosed space in which the inner joint member 46 and its associated components are housed and operate, preferably in a lubricated environment within the housing 37. The opposite end wall 36 is preferably formed with a central opening 38 to receive the second joint member 18 and a joint end portion 40 of the second shaft 20 into a space 42 encaged by the guide rails 26 between the end walls 32, 36. A flexible boot seal (not shown) or other shroud is preferably connected between the shaft 20 and end wall 36 or housing 37 to provide a fluid-tight seal therebetween so as to contain the lubricant within the housing 37 and to prevent debris from entering the interior of the housing 37 through the opening 38.

The torque-transmitting connection 24 between the joint members 12, 18 further includes a plurality of slide couplings 44 corresponding in number to the number of guide rails which support the slide couplings 44. The slide couplings 44 are carried on a central body or spider 46 of the second joint member 18 which is fixed to the second shaft 20 at the joint end portion 40 and is captured in the space 40 between the guide rails 26 and connected movably thereto by the slide couplings 44.

The slide couplings 44 are disposed about the guide rails 26 so as to be captured by the guide rails 26 against radial and rotational movement while permitted to slide axially, and are further captured by the spider 46 against relative axial movment but permitted to move radially and tilt angularly relative to the spider. In other words, the slide couplings 44 are moveable with the spider 46 axially along the outer guide surfaces 28 of the guide rails 26 during angulation and plunging movement of the spider 46 relative to the guide rails 26, or vice versa, and the slide couplings 44 are further slideable on the spider 46 in a direction transverse and preferably radially of the second axis 22 of the second joint member 18 in response to movement of the joint members 12, 18 through a joint angle the slide couplings 44 are preferably supported by the spider 46 in a common plane perpendicular to the second axis 22. As the joint angle changes or the shafts 14, 20 are rotated through a fixed or changing angle, the plane of the slide couplings 44 becomes inclined or skewed relative to the first axis 16 about which the guide rails 26 are fixed in their spatial relation to the axis and one another. The radial sliding movement of the slide couplings 44 on the spider 46 enables the slide couplings 44 to remain connected both to the spider 46 and the guide rails 26 as the distance from the center of the slide couplings along the axis 30 of the guide rails 26 increases with increasing joint angle relative to the joint center C formed at the intersection of the first and second axis 16, 22 of the joint members 12, 18. This ability of the slide couplings 44 to float radially on the spider 46 while held by the guide rails delivers a constant velocity output of the joint assembly 10, as the slide couplings 44 remain in the plane of the spider 46 while sliding along the guide rails 26 through all joint angles.

In addition to the relative radial sliding movement of the slide couplings 44 relative to the spider 46, the slide couplings 44 are further pivotal relative to the spider 46 in order to maintain the slide couplings in axial alignment with the guide axis 30 of the guide rails 26 during a change in joint angle or transmission of torque through a fixed or changing joint angle. This ability of the slide couplings 44 to pivot or angulate relative to the spider 46 enables the joint members 12, 18 to translate or plunge axially of one another at a fixed or changing joint angle during transmission of torque through the joint assembly 10 between the shafts 14, 20.

In the preferred embodiment, the joint center C is provided at the axial center of the plane of the spider 46 along the first axis 16 and remains fixed with respect to the spider 46 through changes in joint angle and during transmission of torque through a fixed or changing joint angle, but translates along the second axis 22 of the second joint member 18 with a change in the relative axial movement or plunge of the joint members 12, 18. Thus, the joint center is fixed with respect to the center location of the first joint member 12, but translates along the second axis 22 with the axial displacement of the first and second joint members 12, 18.

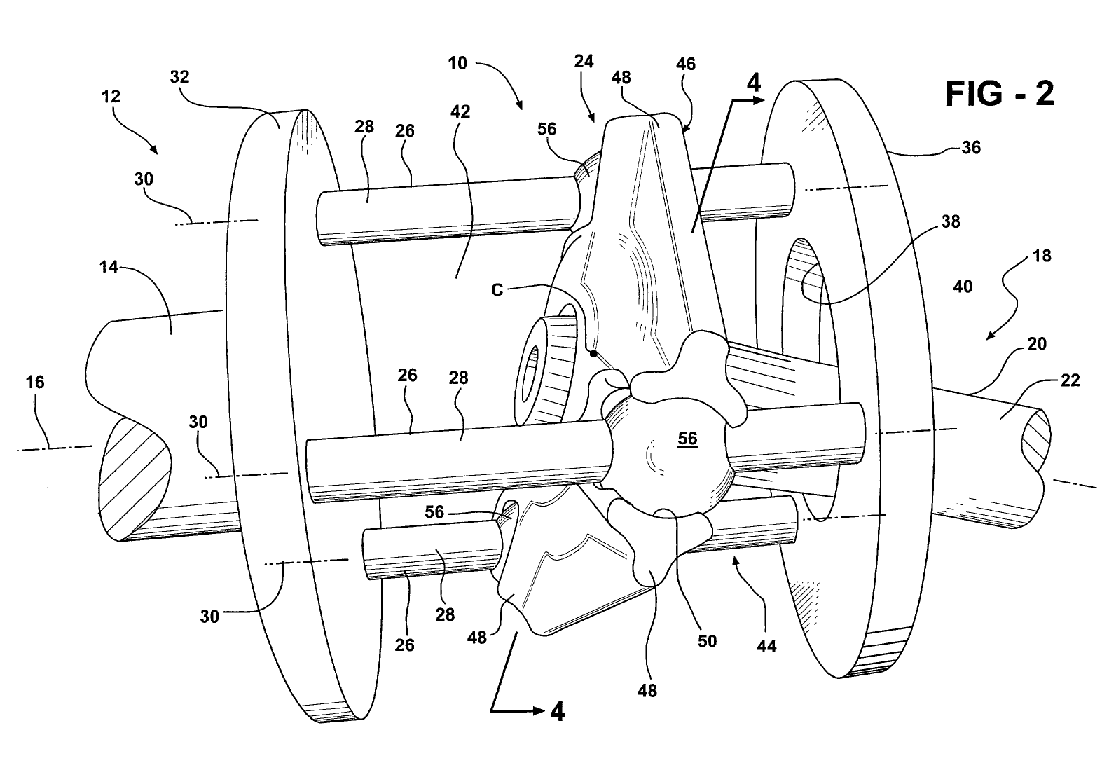

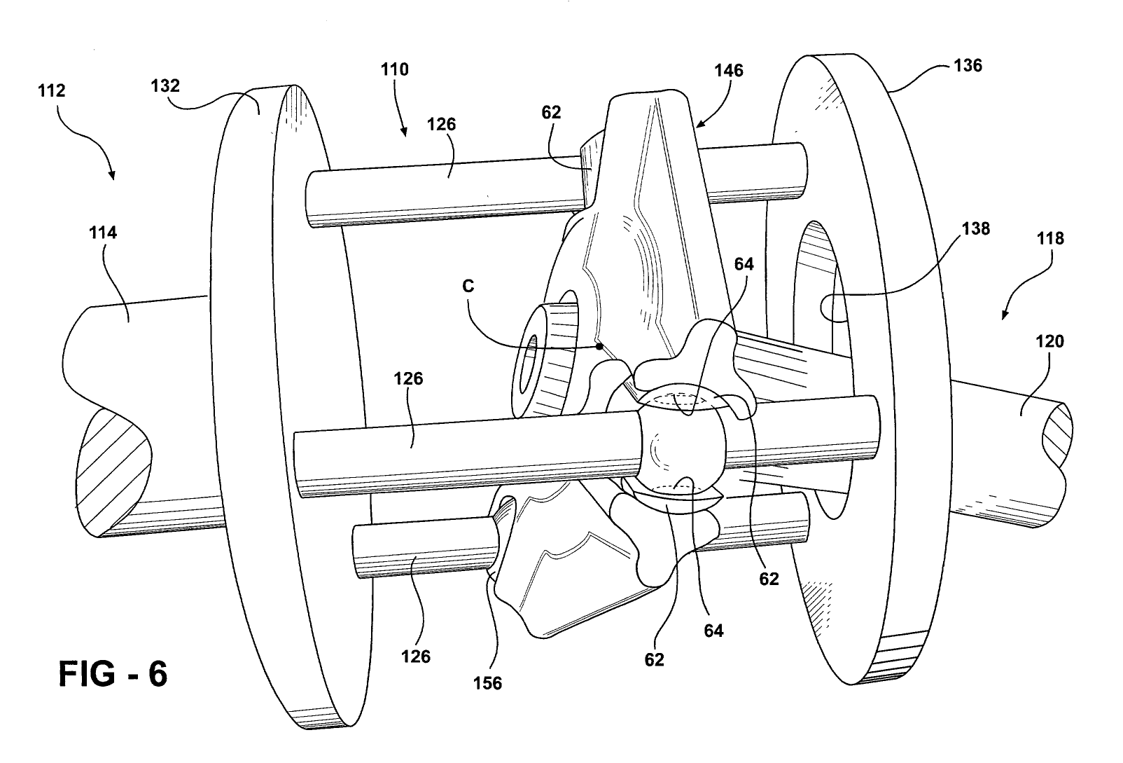

Turning now in greater detail to FIGS. 2-6, a preferred construction of the slide couplings 44 is shown according to the first embodiment. The spider 46 is formed preferably with three arms or lobes 48 which are aligned radially with the guide rails 26 and are each formed with a channel 50 whose laterally spaced side walls 52 straddle a respective one of the guide rails 26. The side walls 52 are formed with opposing radially extending, parallel, concave slide grooves or sockets 54 disposed on opposite transverse sides of the respective guide rails.

The slide couplings 44 each further include a ball member 56 having an outer convex and preferably spherical bearing surface 58 engaging and captured by the walls of the slide socket 54, enabling the ball member 56 to both pivot and slide relative to the arms 48 of the spider 46. Each ball member 56 is formed with a central opening or passage 60 to receive a respective one of the guide rails 26 therein and to capture the ball members 56 on the respective guide rails 26 while enabling the ball members 56 to slide along the guide rails 26. The openings 60 have a shape that complements that of the outer guide surfaces 28 of the guide rails 26 to enable the relative sliding movement therebetween.

The spider 46 may be fabricated of any of a number of rigid materials, such as plastics, metal or composites and the like, and in the first preferred embodiment the channels 50 are configured to directly support the pivoting and sliding movement of the ball members 56 through direct contact with the walls of the slide socket 54. The ball members 56 may likewise be fabricated of any of a number of materials such as those already mentioned above for the other components, and may be selected in relation to the material used for the guide rails 26 and spider 46 so as to minimize friction and wear of the components while providing adequate strength. One suitable combination comprises a metal ball member 56 slideable along metal guide rails 26 with each being hardened to minimize friction and wear, in combination with a strong, tough, low friction plastics material such as glass-filled nylon used for the spider 46. This is but one of an endless combination of materials that could be used for the mating components to maximize a desired properties of the joint, such as strength, wear, low friction, cost, ease of manufacture, and the like. Those skilled in the art will thus appreciate that the invention contemplates virtually any combination of materials and associated properties that result therefrom depending upon the requirements of a particular application.

Turning now to the alternative embodiment of FIG. 7, the same basic joint configuration is shown except there is a slight modification in the construction of the slide couplings 144 of the joint. The same reference numerals are use to identify like parts and features of the second embodiment as those used for the first embodiment of FIGS. 1-5, but are offset by 100. The slide couplings 144 each include a ball member 156 having a convex outer surface 158 and central opening 160 as described previously. The second embodiment differs in that the channels 150 of the arms 148 of the spider 146 do not directly support the ball member 156, but rather are fitted with slide inserts 62 fabricated preferably of metal having outer convex surfaces which are engaged by and slide along the slide socket 154 of the arms 148 to provide the relative sliding movement of the slide couplings 144 relative to the second joint member 118. The slide inserts 62 are formed on their inward facing surfaces with ball sockets or cups 64 which receive and embrace the ball members 156 and support the ball members 156 for pivotal movement relative to the slide inserts 62 and the second joint member 118. The provision of the slide inserts 62 offers another opportunity to introduce a desired material and associated property into the joint assembly 110 without having to make the entire spider 146 out of a material desired to support the movement of the ball member 156. The slide inserts 62 can be fabricated, for example, of a hardened metal such as steel or the like which glides against metal or plastic surfaces of the slide sockets 154 of the spider 146 and whose ball socket 164 supports the ball member 156 which may likewise be fabricated of a compatible hardened metal to minimize wear and friction of the slide couplings 54.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A constant velocity joint assembly for transmitting torque between two rotatable shafts, said joint assembly comprising:
a first joint member secured to a first of said shafts and having an associated first axis;
a second joint member secured to a second of said shafts and having an associated second axis; and
a torque-transmitting connection between said joint members including a plurality of guide rails carried by said first joint member disposed in parallel relationship to one another and to said first axis and presenting outer guide surfaces, and a plurality of slide couplings carried by said second joint member and disposed about said outer guide surface of said guide rails to support said second joint member against rotation relative to said first joint member such that rotation of one of said joint members imparts rotation to the other of said joint members through said slide couplings, said slide couplings being slideable with said second joint member axially along said outer guide surfaces of said guide rails to provide relative axial translation of said joint members, said slide couplings being further slideable on said second joint member transversely of said second axis and pivotable relative to said second joint member to accommodate relative angulation of said joint members.

2. The assembly of claim 1 wherein said guide rails comprise a plurality of rigid rods.

3. The assembly of claim 2 wherein said outer guide surfaces of said rods have a convex curvature in a direction transverse to said second axis.

4. The assembly of claim 2 wherein said guide surface of said rods is circumferentially continuous.

5. The assembly of claim 2 wherein said first joint member includes an end wall transverse to said first axis supporting one end of said rods.

6. The assembly of claim 5 wherein said first joint member includes an opposite end wall supporting an opposite end of said rods.

7. The assembly of claim 2 wherein said rods are cylindrical in configuration.

8. The assembly of claim 1 wherein said slide couplings each include a ball member having a central opening through which an associated one of said guide rails passes.

9. The assembly of claim 8 wherein said slide couplings each include a radially extending slide socket supporting an associated one of said ball members for relative sliding movement radially along said slide socket and for relative pivotal movement within said socket.

10. The assembly of claim 9 wherein each of said slide sockets comprise opposing side walls of said second joint member embracing an associated one of said balls and straddling said guide members.

11. The assembly of claim 10 wherein said opposing channel portions are formed as one piece with said second joint member.

12. The assembly of claim 1 wherein said second joint member comprises a spider disposed between said guide rails.

13. The assembly of claim 1 including a joint center which translates along said first axis during said relative translational movement of said joint members.

14. The assembly of claim 1 wherein said outer guide surfaces of said guide rails face radially outwardly with respect to a longitudinal guide axis of each of said guide rails.

15. The assembly of claim 8 wherein said slide couplings include slide inserts supported slideably by said second joint member for said transverse movement relative to said second axis and supporting said ball members for pivotal movement relative to said slide inserts.
